(19) United States
(12) Patent Application Publication
(10) Pub. No.: US 2011/0068504 A1
(43) Pub. Date: Mar. 24, 2011

(54) RELEASE PLATE FOR USE IN IMPRINTING METHOD, MOLD STRUCTURE AND IMPRINTING METHOD

(76) Inventor: Manabu TOBISE, Ashigarakami-gun (JP)

(21) Appl. No.: 12/883,306

(22) Filed: Sep. 16, 2010

(30) Foreign Application Priority Data
Sep. 18, 2009 (JP) 2009-217235

(51) Int. Cl. B29C 59/00

(52) U.S. Cl. 264/293; 425/385; 425/384

(57) ABSTRACT

A release plate that is provided on a mold structure for use in an imprinting method in which a concavo-convex pattern is transferred to a resist layer composed of an imprint resist composition on a substrate, and that is used to separate the mold structure from the resist layer, the release plate including at least two metal layers which curve by heating and return to their original shape at normal temperature.

### BACKGROUND OF THE INVENTION

1. Field of the Invention

The present invention relates to a release plate for use in an imprinting method, a mold structure and an imprinting method.

2. Description of the Related Art

Organic electroluminescence elements (organic EL elements) have advantages in terms of display performance, such as high visibility and less viewing angle dependence, so that they are widely used for displays, lights, etc. Also, the organic electroluminescence elements are advantageous in that the displays, the lights, etc. can be reduced in weight and thickness.

To produce an organic EL element, an imprinting method (imprinting process) is employed in which, using a mold structure (hereinafter referred to also as “mold”) for forming a resist pattern, a desired pattern is transferred to a resist layer (imprint resist layer) formed over the surface of a sealing layer protecting an organic EL element.

This imprinting method is exemplified by a method in which a resist layer made of a thermoplastic or photocurable resin is formed on a sealing layer formed over the entire surface of an organic EL layer, a mold processed so as to have a desired shape is closely attached to the resist layer and then pressed against the resist layer, which is accompanied by heating of the resin or irradiation of the resin with light so as to cure the resin, then the mold is separated from the resist layer, which allows a pattern corresponding to the pattern formed on the mold to be left on the resist layer, then the portions where the resist layer has been removed are etched by reactive ion etching (RIE) so as to pattern the organic EL layer, and a desired organic EL element is obtained.

Generally, as a mold is pressed against a resist layer, the contact area between the resist layer and the mold increases. Therefore, separation of the mold from the resist layer requires a great deal of stress. Consequently, in the case where a glass mold and/or a glass substrate of an organic EL element are/is used, there is a problem in which the glass breaks, part of a resist layer sticks to the mold instead of being separated therefrom, or the resist layer or the mold is damaged. Especially when the resist layer is formed of a photocurable resin, there is a problem in which the photocurable resin is the same or similar to a component used in a general adhesive and thus separation of the mold from the resist layer is even more difficult.

To solve such problems, there have been proposed a method and an apparatus wherein when a mold is separated from a resist layer, compressed air is blown from below a substrate with the resist layer thereon toward the mold so as to make it easier to separate the mold from the resist layer (Japanese Patent Application Laid-Open (JP-A) No. 2007-230235). However, when a large mold is used as in this proposal, great stress is applied to the mold and the whole of a resist layer, and thus merely blowing compressed air does not help separate the mold from the resist layer in some cases. Moreover, a large apparatus for blowing the compressed air is required, and thus there is a cost-related problem.

There has been proposed a method for reducing stress applied when a mold is separated, by using a highly elastic, soft material as the material constituting the mold (refer to JP-A No. 2009-82207). However, this proposal presents a problem in which when a complex pattern is transferred to a resist layer, the pattern formed on the mold is not completely transferred to the resist layer even though the mold is pressed against the resist layer because the mold is highly elastic.

There has been proposed a method for making it easier to separate a mold from a resist layer by fluorinating the mold surface (refer to JP-A No. 2008-36859). This proposal reports that this method is effective to some extent. However, there is still a problem in which a great deal of stress is applied when the mold is separated from the resist layer, and a solution to the problem is being demanded in reality.

### BRIEF SUMMARY OF THE INVENTION

The present invention provides a release plate for use in an imprinting method, which makes it possible to reduce damage done to a resist layer and a mold, by reducing stress applied when the mold is detached from the resist layer; a mold structure including the release plate; and an imprinting method.

As a result of carrying out a series of earnest examinations to solve the problems, the present inventors have found that, by providing a mold with a release plate including metal layers which curve by heating and return to their original shape at normal temperature, it is possible to reduce stress applied when the mold is separated from a resist layer.

Means for solving the problems are as follows.

<1> A release plate that is provided on a mold structure for use in an imprinting method in which a concavo-convex pattern is transferred to a resist layer composed of an imprint resist composition on a substrate, and that is used to separate the mold structure from the resist layer, the release plate including: at least two metal layers which curve by heating and return to their original shape at normal temperature.
<2> The release plate according to <1>, wherein the metal layers have a two-layer structure composed of a first metal layer and a second metal layer, and the coefficient of thermal expansion of the first metal layer by heating is greater than the coefficient of thermal expansion of the second metal layer by heating under the same temperature condition.
<3> The release plate according to <1>, wherein the first metal layer is a spring layer with springiness, and the second metal layer is a shape memory alloy layer composed of a shape memory alloy.
<4> The release plate according to <1>, wherein the metal layers have a plurality of through holes.
<5> A mold structure used to press against a resist layer composed of an imprint resist composition, including: a substrate; a concavo-convex pattern which is composed of a plurality of convex portions and formed on one surface of the substrate; and a release plate provided on the other surface of the substrate opposite to the one surface, wherein the release plate is a release plate that is provided on a mold structure for use in an imprinting method in which a concavo-convex pattern is transferred to a resist layer composed of an imprint resist composition on a substrate, and that is used to separate the mold structure from the resist layer, and wherein the release plate includes at least two metal layers which curve by heating and return to their original shape at normal temperature.
<6> The mold structure according to <5>, wherein a release agent has been applied to the concavo-convex pattern.
<7> The mold structure according to <5>, wherein the metal layers constituting the release plate have a two-layer structure composed of a first metal layer and a second metal layer disposed in this order as seen from the side of the other surface of the substrate, and the coefficient of thermal expansion of the first metal layer by heating is greater than the coefficient of thermal expansion of the second metal layer by heating under the same temperature condition.
<8> The mold structure according to <5>, wherein the metal layers are heated locally or entirely.
<9> The mold structure according to <7>, wherein the first metal layer is a spring layer with springiness, and the second metal layer is a shape memory alloy layer composed of a shape memory alloy.
<10> An imprinting method including: pressing a mold structure against a resist layer, which is composed of an imprint resist composition and formed on a substrate of an object to be processed, so as to transfer a concavo-convex pattern of the mold structure to the resist layer; and heating a release plate so as to thermally expand at least two metal layers and thus to allow an end of the mold structure to curve in a direction opposite to the pressing direction, and thereby separating the mold structure from the resist layer, wherein the mold structure is a mold structure used to press against a resist layer composed of an imprint resist composition, which includes: a substrate; the concavo-convex pattern which is composed of a plurality of convex portions and formed on one surface of the substrate; and the release plate provided on the other surface of the substrate opposite to the one surface, wherein the release plate is a release plate that is provided on a mold structure for use in an imprinting method in which a concavo-convex pattern is transferred to a resist layer composed of an imprint resist composition on a substrate, and that is used to separate the mold structure from the resist layer, and wherein the release plate includes the at least two metal layers which curve by heating and return to their original shape at normal temperature.
<11> The imprinting method according to <10>, wherein the metal layers are heated locally or entirely.

The present invention solves the problems in related art and provides a release plate for use in an imprinting method, which makes it possible to reduce damage done to a resist layer and a mold, by reducing stress applied when the mold is detached from the resist layer; a mold structure including the release plate; and an imprinting method.

### BRIEF DESCRIPTION OF THE DRAWINGS

FIG. 1A is a perspective view showing an example of a release plate.

FIG. 1B is a perspective view showing an example of a release plate having through holes.

FIG. 2 is a drawing showing the manner in which a shape memory alloy layer and a spring layer are joined together.

FIG. 3 is a perspective view showing an example of a mold.

FIG. 4A is a cross-sectional view showing a stage before a mold is pressed against a resist layer.

FIG. 4B is a cross-sectional view showing the state in which the mold is being pressed against the resist layer and the resist layer is being cured.

FIG. 4C is a cross-sectional view showing the state in which the mold and the resist layer are being separated from each other while a release plate is being heated.

### DETAILED DESCRIPTION OF THE INVENTION

The following delineates a release plate, a mold structure and an imprinting method according to the present invention.

### (Release Plate)

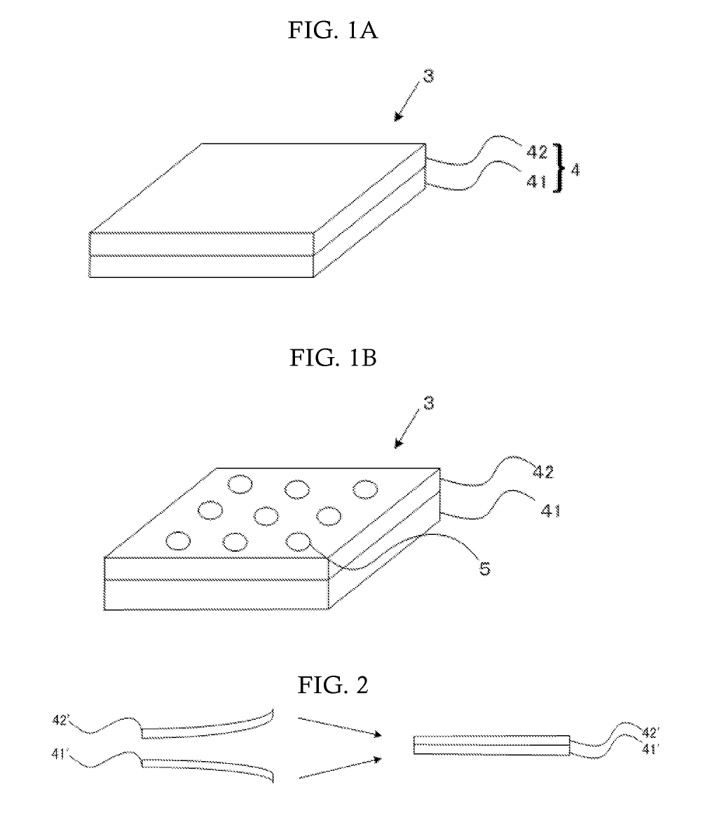

FIG. 1A is a perspective view showing the structure of a release plate of the present invention. A release plate 3 of the present invention includes at least two metal layers 4. In FIG. 1A, the metal layers 4 are composed of a first metal layer 41 and a second metal layer 42. The first and second metal layers 41 and 42 curve by heating and return to their original shape at normal temperature. The release plate 3 is used in the after-mentioned imprinting method in which a mold is pressed against a resist layer so as to transfer a concavo-convex pattern formed on a surface of the mold to the resist layer. It should be noted that although a case where the metal layers 4 have a two-layer structure is explained (for the sake of simplicity), the metal layers 4 may be composed of three or more metal layers.

For the first metal layer 41, a metal which thermally expands by being locally or entirely heated and returns to its original shape at normal temperature is used. For the second metal layer 42, a metal which thermally expands to a lesser extent than the metal for the first metal layer 41 is used. The foregoing structure allows the metal layers 4 to curve due to the difference in thermal expansion between the first and second metal layers 41 and 42 at the time of heating. Accordingly, the coefficient of thermal expansion (coefficient of linear expansion) of the metal used for the first metal layer 41 is preferably 10×10⁻⁶/° C. or greater, more preferably 15×10⁻⁶/° C. or greater, particularly preferably 20×10⁻⁶/° C. or greater. Meanwhile, the coefficient of thermal expansion (coefficient of linear expansion) of the metal used for the second metal layer 42 is preferably 5×10⁻⁶/° C. or less, more preferably 3×10⁻⁶/° C. or less, particularly preferably 2×10⁻⁶/° C. or less. When the coefficients of thermal expansion of the metals are in the respective preferred ranges, stress applied to a resist layer and a mold (mentioned later) can be reduced.

The metal used for the first metal layer 41 is not particularly limited as long as the above-mentioned conditions are satisfied and the metal thermally expands by being heated and returns to its original shape at normal temperature. And the metal may be suitably selected according to the intended purpose. Examples thereof include aluminum, tin and zinc.

The metal used for the second metal layer 42 is not particularly limited as long as it has a small coefficient of thermal expansion, and it may be suitably selected according to the intended purpose. Examples thereof include invar, stainless steel invar and Super Invar.

Provided that the metal layers 4 can curve (for separation of a mold from a resist layer) by being heated, the first metal layer 41 and the second metal layer 42 may if necessary be a spring layer 41′ with springiness and a shape memory alloy layer 42′ respectively. The shape memory alloy is normally in the shape of a curve. The shape memory alloy layer 42′ and the spring layer 41′ are joined together such that the shape memory alloy forms a flat surface, pulled by the spring layer 41′, as shown in FIG. 2.

The first metal layer 41 is preferably the spring layer 41′ with springiness. The metal usable for the spring layer 41′ is not particularly limited as long as it does not easily deform plastically and can maintain the flatness of the metal layers 4. And the metal may be suitably selected according to the intended purpose. Examples thereof include SUS-304 (stainless steel) and C5210 (phosphor bronze).

The second metal layer 42 is preferably the shape memory alloy layer 42′ composed of a shape memory alloy. The shape memory alloy usable for the shape memory alloy layer 42′ is not particularly limited and may be suitably selected is according to the intended purpose. Examples thereof include titanium-nickel alloys and iron-manganese-silicon alloys.

The first metal layer 41 preferably has a thickness of 1 mm to 100 mm, more preferably 1 mm to 50 mm, particularly preferably 1 mm to 30 mm. When the thickness of the first metal layer 41 is less than 1 mm, it may be impossible to separate a mold from a resist layer because a sufficient amount of force for the separation may not be obtained. When the thickness thereof is greater than 100 mm, the metal layers 4 as a whole may not curve. Meanwhile, when the thickness of the first metal layer 41 is in the particularly preferred range, there is an advantage in terms of separating performance.

The second metal layer 42 preferably has a thickness of 1 mm to 100 mm, more preferably 1 mm to 50 mm, particularly preferably 1 mm to 30 mm. When the thickness of the second metal layer 42 is less than 1 mm, it may be impossible to separate the mold from the resist layer because the second metal layer 42 may not have sufficient curvature. When the thickness thereof is greater than 100 mm, the metal layers 4 as a whole may not curve. Meanwhile, when the thickness of the second metal layer 42 is in the particularly preferred range, there is an advantage in terms of separating performance.

The manner in which the first and second metal layers 41 and 42 are joined together is not particularly limited and may be suitably selected according to the intended purpose. For example, they may be joined together by roll bonding.

Also, as shown in FIG. 1B, the release plate 3 may be provided with a plurality of through holes 5 such that the through holes 5 go all the way through the first and second metal layers 41 and 42. The provision of the through holes 5 makes it possible to expose the after-mentioned resist layer via the through holes 5 in the case where the resist layer is a photocurable resin.

If necessary, a sheet heater (not shown) may be provided over the release is plate 3 (metal layers 4). The provision of the sheet heater makes it possible to directly heat portion(s) intended to be heated, and thus to curve the metal layers 4 effectively. Note that the sheet heater may be provided entirely over the release plate 3 (metal layers 4) or locally over portion(s) of the release plate 3 (metal layers 4) intended to be heated. Examples of the sheet heater provided over the release plate 3 (metal layers 4) include aluminum sheet heaters and silicon sheet heaters.

### (Mold Structure)

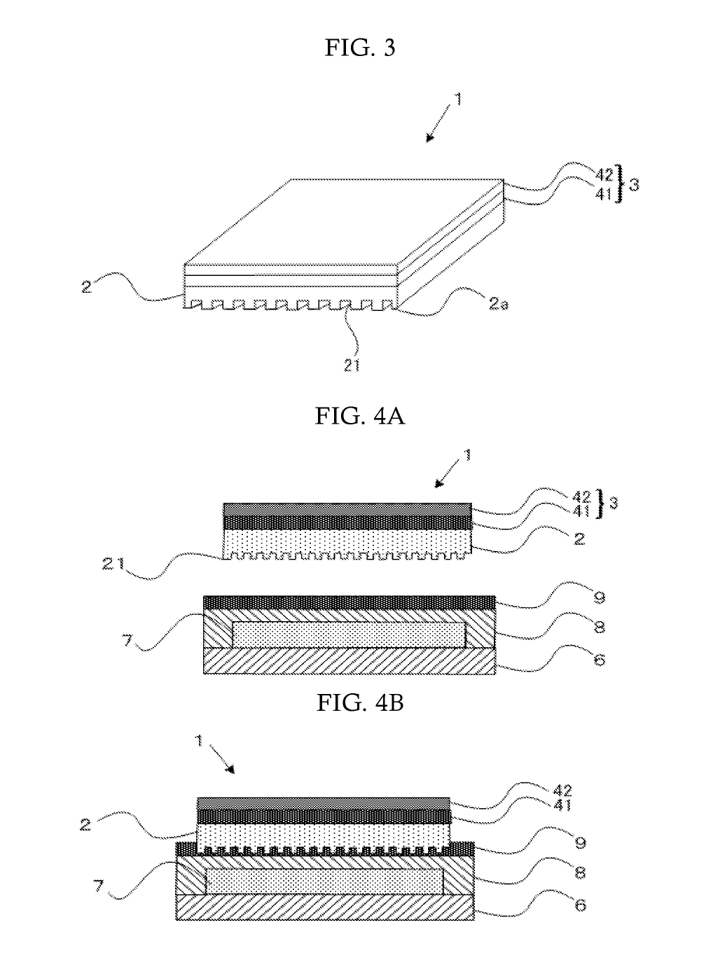

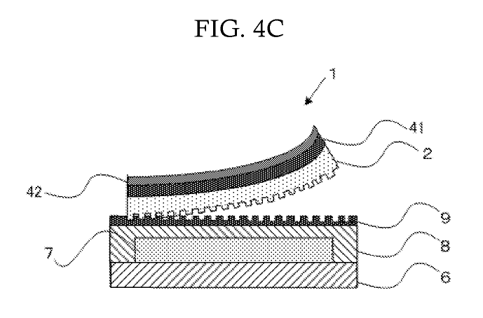

FIG. 3 is a partial perspective view showing the structure of a mold structure of the present invention used to press against an object to be processed (for example to press against a resist layer 9 in FIGS. 4A to 4C, mentioned later). As shown in FIG. 3, a mold structure (referred to also as “mold”) 1 includes a substrate 2, a plurality of convex portions 21 and a release plate 3. If necessary, the mold structure 1 may further include a layer of a release agent (not shown), which is formed so as to cover at least the convex portions 21; and other member(s).

### <Substrate>

The material for the substrate 2 is not particularly limited and may be suitably selected according to the intended purpose. Examples thereof include nickel, silicon, quartz, glass, aluminum, ceramics and synthetic resins.

The substrate 2 preferably has a thickness of 100 μm to 10 mm, more preferably 200 μm to 5 mm.

### <Convex Portions>

The convex portions 21 are formed on one surface 2a (hereinafter referred to also as “reference surface 2a”) of the substrate 2. Regarding the convex portions 21, the plurality of convex portions 21 are arranged at predetermined intervals in a radius direction of the substrate 2 and thereby form a concavo-convex pattern (transfer pattern).

The cross-sectional shape of each convex portion 21 is not particularly limited and may be suitably selected according to the intended purpose. Nevertheless, the cross-sectional shape is preferably a rectangle, more preferably a tapered shape.

### <Release Agent>

The release agent is applied over the surface on the side of the surface 2a of the substrate 2 (the side where the concavo-convex pattern composed of the convex portions 21 is formed). Also, a release layer made of the release agent may be formed by surface treatment so as to cover the surface on the side of the surface 2a of the substrate 2.

The material for the release agent is not particularly limited as long as it is a water-repellent material which yields smooth separation from a resist layer, and it may be suitably selected according to the intended purpose. Examples thereof include a solution composed of a methyl nonafluoroisobutyl ether, methyl nonafluorobutyl ether and a fluorine-based polymer; and a solution composed of a dihydroxypropaneoxymethyl derivative of a perfluoropolyoxyalkane and a fluorine-based polymer. Specific suitable examples thereof as commercially available products include EGC-1720 (manufactured by 3M Company).

The material for the release agent preferably has a viscosity of 3 mPa·s or less, more preferably 1 mPa·s or less, particularly preferably 0.6 mPa·s or less. The viscosity of the material for the release agent can, for example, be measured using a viscosity/viscoelasticity measuring apparatus (RHEOSTRESS RS 600, manufactured by EKO Instruments Co., Ltd.).

The release layer made of the release agent preferably has a thickness of 50 nm or less, more preferably 25 nm or less, particularly preferably 10 nm or less. When the thickness of the release layer is less than 10 nm, it is difficult to separate the mold from a resist layer.

The thickness of the release layer can, for example, be measured using a spectroscopic ellipsometer (MARY-102, manufactured by FiveLab Co., Ltd.).

### <Release Plate>

The release plate 3 is positioned on the surface of the substrate, which is opposite to the surface where the convex portions 21 are formed. It is preferred that the release plate 3 be provided on the substrate 2 such that the substrate 2, a first metal layer 41 and a second metal layer 42 are disposed in this order. By employing the foregoing structure and locally or entirely heating the release plate 3 (metal layers 4), the second metal layer 42 having a smaller coefficient of thermal expansion than the first metal layer 41 allows the substrate 2 to curve in the opposite direction to the pressing direction, which makes it possible to reduce stress applied to a resist layer and the mold 1 and thus detach the mold 1 from the resist layer in a favorable manner.

Also, the second metal layer 42 and the first metal layer 41 may if necessary be a shape memory alloy layer 42′ composed of a shape memory alloy, and a spring layer 41′ with springiness, respectively.

### <Other Member(s)>

The other member(s) is/are not particularly limited as long as effects of the present invention are not impaired, and it/they may be suitably selected according to the intended purpose. Examples thereof include a sealing layer which performs a sealing function by surrounding the mold 1.

### <Object to be Processed>

The object to be processed, to which the concavo-convex pattern of the mold 1 is transferred, is exemplified by an object formed by disposing a substrate 6, an organic EL layer 7 and a resist layer 9 in this order as shown in FIGS. 4A to 4C; the concavo-convex pattern of the mold 1 is transferred to the resist layer 9. It should be noted that although a case where the object to be processed is an organic EL element is explained (for the sake of simplicity), the object to be processed may be otherwise and may, for example, be a magnetic recording medium or the like.

### <Substrate of Object to be Processed>

The shape, structure, size, material, etc. of the substrate 6 of the object to be processed are not particularly limited and may be suitably selected according to the intended purpose. For example, regarding the shape, the substrate 6 will be shaped like a disc in the case where the object is an information recording medium. The structure may be a single-layer structure or a laminated structure. The material may be suitably selected from substrate materials known in the art, examples of which include nickel, aluminum, glass, silicon, quartz and transparent resins. These substrate materials may be used individually or in combination. Among these, quartz, glass and transparent resins are preferable in terms of transparency, particularly quartz.

The substrate 6 may be a suitably synthesized substrate or a commercially available substrate. The thickness of the substrate 6 is not particularly limited and may be suitably selected according to the intended purpose. Nevertheless, the thickness thereof is preferably 50 μm or greater, more preferably 100 μm or greater. When the thickness of the substrate 6 is less than 50 μm, it is possible that flexure may occur on the mold side when the object to be processed and the mold 1 are closely attached to each other, and thus they may not be closely attached to each other in a uniform manner.

### <Organic EL Layer>

The organic EL layer 7 includes an anode, a cathode, and organic compound layers (which include at least a hole transport layer, a light-emitting layer and an electron transport layer) between the anode and the cathode.

The anode is, in general, satisfactory as long as it is an electrode having a function of supplying holes to the light-emitting layer as a component of the organic compound layers. The shape, structure, size, etc. of the anode are not particularly limited, and the material for the anode may be suitably selected from electrode materials known in the art, according to the intended use and purpose of the organic EL layer 7.

Suitable examples of the material for the anode include metals, alloys, meta oxides, conductive compounds, and mixtures thereof. Specific examples of the material for the anode include conductive metal oxides such as tin oxides doped with antimony, fluorine, etc. (e.g. ATO and FTO), tin oxides, zinc oxides, indium oxides, indium tin oxide (ITO) and indium zinc oxide (IZO); metals such as aluminum, gold, silver, chromium and nickel; mixtures or laminated products composed of the metals and the conductive metal oxides; inorganic conductive materials such as copper iodide and copper sulfide; organic conductive materials such as polyaniline, polythiophene and polypyrrole; and laminated products composed of these and ITO. Among these, metals are preferable, with aluminum being particularly preferable in terms of productivity, conductivity, reflectance and so forth.

Patterning at the time of the formation of the anode may be performed by chemical etching such as photolithography, or physical etching such as etching with a laser. Alternatively, the patterning may be performed by vacuum vapor deposition, sputtering, etc. with the use of a mask or performed by a lift-off method or printing method.

The thickness of the anode may be suitably selected according to the material constituting the anode and thus cannot be unequivocally decided. Nevertheless, the thickness is preferably in the range of 10 nm to 50 μm, more preferably 50 nm to 20 μm.

The cathode is, in general, satisfactory as long as it is an electrode having a function of injecting electrons into the light-emitting layer as a component of the organic compound layers. The shape, structure, size, etc. of the cathode are not particularly limited, and the material for the cathode may be suitably selected from electrode materials known in the art, according to the intended use and purpose of the object to be processed.

Examples of the material constituting the cathode include metals, alloys, metal oxides, electroconductive compounds, and mixtures thereof. Specific examples thereof include alkali metals (such as Li, Na, K and Cs), alkaline earth metals (such as Mg and Ca), gold, silver, lead, aluminum, sodium-potassium alloy, lithium-aluminum alloy, magnesium-silver alloy, indium and rare earth metals such as ytterbium. These may be used individually; nevertheless, in view of a balance between stability and electron injection capability, it is preferred that two or more of these be used in combination.

Among the foregoing materials usable as the material constituting the cathode, alkali metals and alkaline earth metals are preferable in terms of electron injection capability, and silver-based materials are preferable in that superior film quality and superior light reflection can be yielded. The silver-based materials are as follows: silver, and alloys or mixtures which are each composed of silver and 0.01% by mass to 10% by mass of an alkali metal or alkaline earth metal (for example, lithium-silver alloy and magnesium-silver alloy).

Parenthetically, materials usable for the cathode are delineated in JP-A Nos. 02-15595 and 05-121172, and the materials delineated therein can be applied to the present invention.

The method for forming the cathode is not particularly limited, and the cathode may be formed in accordance with a method known in the art. For example, the cathode may be formed in accordance with a method suitably selected from wet methods such as coating and printing, physical methods such as vacuum vapor deposition, sputtering and ion plating, and chemical methods such as CVD and plasma CVD, in view of its suitability for the material constituting the cathode. In the case where metal(s) or the like is/are selected as the material for the cathode, one kind thereof or two or more kinds thereof may be simultaneously or sequentially used in sputtering or the like to form the cathode.

The thickness of the cathode may be suitably selected according to the material constituting the cathode and thus cannot be unequivocally decided. Nevertheless, the thickness is preferably in the range of 10 nm to 5 μm, more preferably 15 nm to 1 μm. Also, the cathode may be transparent or opaque. A transparent cathode can be formed by depositing the cathode material so as to have a small thickness of 1 nm to 20 nm and laying a transparent conductive material (such as ITO or IZO) thereon.

The light-emitting layer is a layer which has a function of receiving holes from the anode and a hole transport material and electrons from the cathode and an electron transport material upon application of an electric field, providing a place for recombination of the holes and the electrons, and thereby emitting light.

The light-emitting layer is not particularly limited as long as it emits light upon application of an electric field, and it may be suitably selected according to the intended purpose. The light-emitting layer may be formed of an organic light-emitting material or an inorganic light-emitting material, preferably an organic light-emitting material in view of luminous efficacy and the capability of enlarging an apparatus.

The material for the light-emitting layer may be selected according to the desired color tone. To obtain light emission of a color which is anywhere between blue and bluish green, for example, the material is preferably selected from fluorescent whitening agents (based upon benzothiazole, benzimidazole, benzoxazole, etc.), metal-chelated oxonium compounds, styrylbenzene compounds, aromatic dimethylidyne compounds and the like. Alternatively, an organic light-emitting layer may be formed by using any of the foregoing materials as a host material and adding a dopant to the host material. Examples of materials usable as the dopant include perylene (blue), which is known to be used as a laser dye.

The hole transport layer is a layer which has a function of receiving holes from the anode or the anode side and transporting the holes to the cathode side.

Examples of the material constituting the hole transport layer include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidyne compounds, porphyrin compounds, organic silane derivatives and carbon.

The method for forming the hole transport layer is not particularly limited, and the hole transport layer can be suitably formed by any of a dry film-forming method (such as vapor deposition or sputtering), a transfer method, a printing method and the like.

In view of reduction in drive voltage, it is preferred that the hole transport layer have a thickness of 500 nm or less, more preferably 1 nm to 500 nm, even more preferably 5 nm to 200 nm, particularly preferably 10 nm to 100 nm.

The electron transport layer is a layer which has a function of receiving electrons from the cathode or the cathode side and transporting the electrons to the anode side.

Examples of the material constituting the electron transport layer include triazole derivatives, oxazole derivatives, oxadiazole derivatives, imidazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, aromatic ring tetracarboxylic acid anhydrides of naphthalene, perylene, etc., phthalocyanine derivatives, metal complexes typified by metal complexes of 8-quinolinol derivatives and metal complexes with benzoxazole or benzothiazole as a ligand, and organic silane derivatives.

The method for forming the electron transport layer is not particularly limited and may be suitably selected according to the intended purpose. For example, the electron transport layer can be formed by a dry film-forming method (such as vapor deposition or sputtering), a transfer method, a printing method, etc.

In view of reduction in drive voltage, it is preferred that the electron transport layer have a thickness of 500 nm or less, more preferably 1 nm to 500 nm, even more preferably 5 nm to 200 nm, particularly preferably 10 nm to 100 nm.

There may be an electron injection layer provided on the surface of the electron transport layer on the cathode side or on the surface of the electron transport layer on the opposite side to the cathode side. It is preferred that the electron injection layer be provided on the surface of the electron transport layer on the cathode side. Preferred examples of the material for the electron injection layer and the method for forming the electron injection layer are the same as the examples of the material and the method mentioned above in relation to the electron transport layer.

It is preferred that the electron injection layer have a thickness of 500 nm or less, more preferably 0.1 nm to 200 nm, even more preferably 0.2 nm to 100 nm, particularly preferably 0.5 nm to 50 nm. The electron injection layer and the electron transport layer may each have a single-layer structure composed of one material or two or more materials selected from the above materials, or may each have a multilayered structure composed of a plurality of layers with the same composition or different compositions.

### <Sealing Layer>

A sealing layer 8 may be provided for the purpose of preventing permeation of moisture from outside. The sealing layer 8 is not particularly limited and may be suitably selected according to the intended purpose, and it may have a single-layer or laminated structure composed of inorganic compound(s) or organic compound(s). Examples of the inorganic compound(s) include SiNₓ, SiON, SiO₂, Al₂O₃ and TiO₂. Examples of the organic compound(s) include silicone polymers, epoxy polymers, acrylic polymers and urethane polymers.

The thickness of the sealing layer 8 is not particularly limited and may be suitably selected according to the intended purpose. Nevertheless, the thickness is preferably in the range of 1 μm to 5 μm, with the lower limit being particularly preferably 1.5 μm and the upper limit being particularly preferably 4 μm.

### <Resist Layer>

The resist layer 9 is a layer formed by applying an imprint resist composition (hereinafter referred to also as “imprint resist solution”) to a substrate of an organic EL element, a magnetic recording medium, etc.

The material constituting the resist layer 9 is not particularly limited and may be suitably selected from materials known in the art, according to the intended purpose. For instance, the resist layer 9 is a layer formed by applying an imprint resist composition, which contains at least a thermoplastic resin or a photocurable resin, to the sealing layer 8 or the substrate 6 for the organic EL layer 7. Examples of the imprint resist composition constituting the resist layer 9 include novolac resins, epoxy resins, acrylic resins, organic glass resins and inorganic glass resins.

It is preferred that the thickness of the resist layer 9 be equivalent to 5% or more, but less than 200% of the height of the convex portions 21 formed on the surface 2a of the mold 1. When the thickness is equivalent to less than 5% of the height, the resist amount is insufficient, and thus it may be impossible to form a desired resist pattern.

The thickness of the resist layer 9 can, for example, be measured as follows: part of the resist layer 9 is separated from the resist layer 9 formed over the substrate 6, and the level difference (height) made after the separation is measured using an AFM apparatus (DIMENSION 5000, manufactured by Nihon Veeco K.K.).

The viscosity of the imprint resist composition can, for example, be measured using an ultrasonic viscometer or the like. The viscosity of the imprint resist composition at 25° C. is preferably in the range of 1 mPa·s to 200 mPa·s, more preferably 1 mPa·s to 100 mPa·s.

### (Imprinting Method)

FIGS. 4A to 4C are cross-sectional views together showing an imprinting method using a mold of the present invention. The mold 1 is placed over the resist layer 9 formed by applying an imprint resist solution over the sealing layer 8 (FIG. 4A). Thereafter, the mold 1 is pressed against the resist layer 9, and while doing so, heat is applied to the resist layer 9 or ultraviolet rays, etc. are applied to the resist layer 9 so as to cure the resist layer 9 and thereby transfer the concavo-convex pattern of the mold 1 to the resist layer 9 (FIG. 4B).

After it has been confirmed that the resist layer 9 has cured and that the concavo-convex pattern of the mold 1 has been transferred to the resist layer 9, the release plate 3 provided as a member of the mold 1 is heated. By heating the release plate 3, the release plate 3 curves in the opposite direction to the pressing direction, and due to the curvature of the release plate 3, the substrate 2 of the mold 1 curves similarly. As the substrate 2 curves, the resist layer 9 and the convex portions 21 pressing against the resist layer 9 separate from each other partially (FIG. 4C).

The temperature at which the release plate 3 is heated is not particularly limited and may be suitably changed according to the object to be processed, the intended use, etc. Nevertheless, it is preferably heated at 80° C. to 130° C., more preferably 90° C. to 120° C., particularly preferably 90° C. to 100° C. When the temperature at which the release plate 3 is heated is lower than 80° C., the release plate 3 may not curve. When the temperature is higher than 130° C., an organic EL element may be damaged by the heating.

The manner in which the release plate 3 is heated is not particularly limited; the release plate 3 may be heated entirely, or the release plate 3 may be heated locally where curvature is intended. Additionally, as described above, a sheet heater may be provided over the upper surface of the release plate 3 (metal layers 4) and the sheet heater may be heated.

### EXAMPLES

The following explains Examples of the present invention. It should, however, be noted that the scope of the present invention is not confined to these Examples

### <Mold Including Release Plate>

A first metal layer containing zinc and a second metal layer containing stainless steel invar were joined together to obtain a release plate. The release plate was jointed to a commercially available mold, such that the first metal layer and the second metal layer were disposed in this order over a substrate of the mold.

### <Production of Organic EL Element>

### —Formation of Light-Emitting Portion—

Under the following conditions, a hole injection layer, a hole transport layer, a light-emitting layer (a blue light-emitting layer, a green light-emitting layer, a red light-emitting layer), an electron transport layer, an electron injection layer and an upper electrode layer were formed in this order over a reflective electrode layer (Al) formed on a TFT (active matrix) substrate.

—Case where Light-Emitting Layer is Green Light-Emitting Layer—

On a reflective electrode layer (anode), a hole injection layer composed of 2-TNATA[4,4′,4″-tris(2-naphthylphenylamino)triphenylamine] and MnO₃ at a proportion (mass ratio) of 7:3 was formed by vacuum vapor deposition so as to have a thickness of 20 nm.

Next, on the hole injection layer, a first hole transport layer composed of 2-TNATA doped with 1.0% by mass of F4-TCNQ (2,3,5,6-tetrafluoro-7,7,88-tetracyanoquinodimethane) was formed by vacuum vapor deposition so as to have a thickness of 141 nm.

Next, on the first hole transport layer, a second hole transport layer composed of α-NPD[N,N′-(dinaphthylphenylamino)pyrene] was formed by vacuum vapor deposition so as to have a thickness of 10 nm.

Next, on the second hole transport layer, a third hole transport layer composed of the hole transport material A (represented by the structural formula below) was formed by vacuum vapor deposition so as to have a thickness of 3 nm.

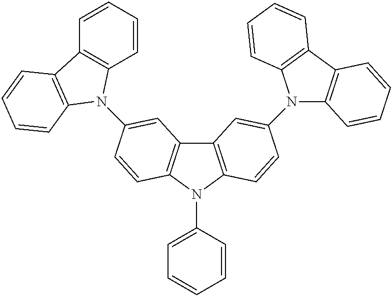

Hole transport material A

Next, on the third hole transport layer, a light-emitting layer composed of CBP(4,4′-dicarbazole-biphenyl) as a host material and the light-emitting material G (represented by the structural formula below) as a light-emitting material at a proportion (mass ratio) of 85:15 was formed by vacuum co-deposition so as to have a thickness of 20 nm.

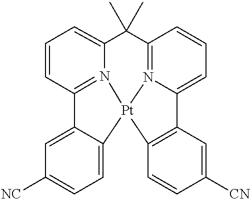

Light-emitting material G

Next, on the light-emitting layer, a first electron transport layer composed of BAlq (aluminum(III)bis(2-methyl-8-quinolinato)-4-phenylphenolate) was formed by vacuum vapor deposition so as to have a thickness of 39 nm.

Next, on the first electron transport layer, a second electron transport layer is composed of BCP (2,9-dimethyl-4,7-diphenyl-1,10-phenanthroline) was formed by vacuum vapor deposition so as to have a thickness of 1 nm.

Next, on the second electron transport layer, a first electron injection layer composed of LiF was formed by vacuum vapor deposition so as to have a thickness of 1 nm.

Next, on the first electron injection layer, a second electron injection layer composed of Al was formed by vacuum vapor deposition so as to have a thickness of 0.5 nm.

Next, on the second electron injection layer, a cathode composed of silver (Ag) was formed by vacuum vapor deposition so as to have a thickness of 20 nm.

—Case where Light-Emitting Layer is Red Light-Emitting Layer—

On a reflective electrode layer (anode), a hole injection layer composed of 2-TNATA[4,4′,4″-tris(2-naphthylphenylamino)triphenylamine] and MoO₃ at a proportion (mass ratio) of 7:3 was formed by vacuum vapor deposition so as to have a thickness of 20 nm.

Next, on the hole injection layer, a first hole transport layer composed of 2-TNATA doped with 1.0% by mass of F4-TCNQ was formed by vacuum vapor deposition so as to have a thickness of 196 nm.

Next, on the first hole transport layer, a second hole transport layer composed of α-NPD[N,N′-(dinaphthylphenylamino)pyrene] was formed by vacuum vapor deposition so as to have a thickness of 10 nm.

Next, on the second hole transport layer, a light-emitting layer composed of BAlq as a host material and the light-emitting material R (represented by the structural formula below) as a light-emitting material at a proportion (mass ratio) of 95:5 was formed by vacuum co-deposition so as to have a thickness of 30 nm.

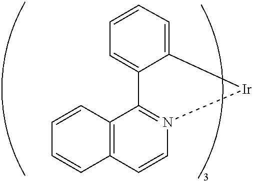

Light-emitting material R

Next, on the light-emitting layer, a first electron transport layer composed of BAlq was formed by vacuum vapor deposition so as to have a thickness of 48 nm.

Next, on the first electron transport layer, a second electron transport layer composed of BCP was formed by vacuum vapor deposition so as to have a thickness of 1 nm

Next, on the second electron transport layer, a first electron injection layer composed of LiF was formed by vacuum vapor deposition so as to have a thickness of 1 nm.

Next, on the first electron injection layer, a second electron injection layer composed of Al was formed by vacuum vapor deposition so as to have a thickness of 0.5 nm.

Next, on the second electron injection layer, a cathode composed of silver (Ag) was formed by vacuum vapor deposition so as to have a thickness of 20 nm.

—Case where Light-Emitting Layer is Blue Light-Emitting Layer—

On a reflective electrode layer (anode), a hole injection layer composed of 2-TNATA[4,4′,4″-tris(2-naphthylphenylamino)triphenylamine] and MnO₃ at a proportion (mass ratio) of 7:3 was formed by vacuum vapor deposition so as to have a thickness of 20 nm.

Next, on the hole injection layer, a first hole transport layer composed of 2-TNATA doped with 1.0% by mass of F4-TCNQ was formed by vacuum vapor deposition so as to have a thickness of 110 nm.

Next, on the first hole transport layer, a second hole transport layer composed of α-NPD[N,N′-(dinaphthylphenylamino)pyrene] was formed by vacuum vapor deposition so as to have a thickness of 10 nm.

Next, on the second hole transport layer, a third hole transport layer composed of the hole transport material A (represented by the structural formula above) was formed by vacuum vapor deposition so as to have a thickness of 3 nm.

Next, on the third hole transport layer, a light-emitting layer composed of mCP(1,3-bis(carbazolyl)benzene) as a host material and the light-emitting material B (represented by the structural formula below) as a light-emitting material at a proportion (mass ratio) of 85:15 was formed by vacuum co-deposition so as to have a thickness of 30 nm.

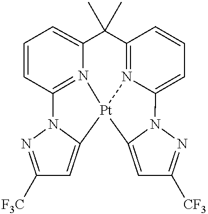

Light-emitting material B

Next, on the light-emitting layer, a first electron transport layer composed of BAlq was formed by vacuum vapor deposition so as to have a thickness of 29 nm.

Next, on the first electron transport layer, a second electron transport layer composed of BCP was formed by vacuum vapor deposition so as to have a thickness of 1 nm

Next, on the second electron transport layer, a first electron injection layer composed of LiF was formed by vacuum vapor deposition so as to have a thickness of 1 nm.

Next, on the first electron injection layer, a second electron injection layer composed of Al was formed by vacuum vapor deposition so as to have a thickness of 0.5 nm.

Next, on the second electron injection layer, a cathode composed of silver (Ag) was formed by vacuum vapor deposition so as to have a thickness of 20 nm.

The area of the light-emitting surface of each light-emitting portion including the light-emitting layer of each color, which was formed over the reflective electrode layer as just described, was 100 μm×100 μm.

On each upper electrode layer thus formed, an SiON layer was formed as a sealing layer by low-temperature CVD so as to have a thickness of 3 μm. The SiON layer was formed so as to cover the organic EL layer as shown in FIGS. 4A to 4C, and the thickness (3 μm) of the formed SiON layer means the distance from the light-emitting surface of the light-emitting portion to the surface of the SiON layer.

On the sealing layer, a resist layer obtained by applying an imprint resist composition containing a thermosetting material was formed so as to have a thickness of 100 μm, and an organic EL element was thus obtained.

### Example 1

The mold including the release plate was pressed against the resist layer of the organic EL element, the resist layer was thermally cured at 80° C., then the whole surface of the release plate was heated at 100° C. so as to curve the release plate, and the resist layer and the mold were thus separated from each other. This process was repeated 100 times, and the number of times part of the resist layer stuck to the is mold instead of being separated therefrom, and the resist layer or the mold was damaged was measured. The results are shown in Table 1.

### Example 2

The separating process was repeated 100 times in the same manner as in Example 1 except that a release plate having through holes was used and a resist layer containing a UV-curable epoxy resin was cured by applying ultraviolet rays to the resist layer via the through holes. The number of times part of the resist layer stuck to the mold instead of being separated therefrom, and the resist layer or the mold was damaged was measured. The results are shown in Table 1.

### Example 3

The separating process was repeated 100 times in the same manner as in Example 1 except that a resist layer containing a UV-curable epoxy resin was formed on a transparent glass substrate and cured by applying ultraviolet rays to the resist layer via the transparent glass substrate. The number of times part of the resist layer stuck to the mold instead of being separated therefrom, and the resist layer or the mold was damaged was measured. The results are shown in Table 1.

### Example 4

The separating process was repeated 100 times in the same manner as in Example 1 except that the resist layer was thermally cured at 100° C. and the resist layer and the mold were separated from each other by allowing the release plate to curve gradually at the same time as the thermal curing of the resist layer. The number of times part of the resist layer stuck to the mold instead of being separated therefrom, and the resist layer or the mold was damaged was measured. The results are shown in Table 1.

### Comparative Example 1

The separating process was repeated 100 times in the same manner as in Example 1 except that a mold without a release plate was used. The number of times part of the resist layer stuck to the mold instead of being separated therefrom, and the resist layer or the mold was damaged was measured. The results are shown in Table 1.

TABLE 1

| | Number of times |
|---|---|
| | resist layer or |
| | mold was damaged |
| Example 1 | 0 |
| Example 2 | 0 |
| Example 3 | 0 |
| Example 4 | 0 |
| Comparative | 45 |
| Example 1 | |

Based upon the results shown in Table 1, it was confirmed that the use of the mold including the release plate according to any one of Examples 1 to 4 made it possible to reduce the force with which the mold was detached from the resist layer, and thus neither the resist layer nor the mold was damaged when the separating process was repeated 100 times. Meanwhile, it was confirmed that when the mold without a release plate according to Comparative Example 1 was used and the resist layer and the mold were separated from each other, the resist layer or the mold was damaged at a great rate.

A release plate, a mold structure and a nanoimprinting method according to the present invention can be suitably utilized as a release plate, a mold structure and a nanoimprinting method which make it possible to reduce the force with which a mold is detached from a resist layer.

What is claimed is:

1. A release plate that is provided on a mold structure for use in an imprinting method in which a concavo-convex pattern is transferred to a resist layer composed of an imprint resist composition on a substrate, and that is used to separate the mold structure from the resist layer, the release plate comprising:
at least two metal layers which curve by heating and return to their original shape at normal temperature.

2. The release plate according to claim 1, wherein the metal layers have a two-layer structure composed of a first metal layer and a second metal layer, and the coefficient of thermal expansion of the first metal layer by heating is greater than the coefficient of thermal expansion of the second metal layer by heating under the same temperature condition.

3. The release plate according to claim 1, wherein the first metal layer is a spring layer with springiness, and the second metal layer is a shape memory alloy layer composed of a shape memory alloy.

4. The release plate according to claim 1, wherein the metal layers have a plurality of through holes.

5. A mold structure used to press against a resist layer composed of an imprint resist composition, comprising:
a substrate;
a concavo-convex pattern which is composed of a plurality of convex portions and formed on one surface of the substrate; and
a release plate provided on the other surface of the substrate opposite to the one surface,
wherein the release plate is a release plate that is provided on a mold structure for use in an imprinting method in which a concavo-convex pattern is transferred to a resist layer composed of an imprint resist composition on a substrate, and that is used to separate the mold structure from the resist layer, and
wherein the release plate comprises at least two metal layers which curve by heating and return to their original shape at normal temperature.

6. The mold structure according to claim 5, wherein a release agent has been applied to the concavo-convex pattern.

7. The mold structure according to claim 5, wherein the metal layers constituting the release plate have a two-layer structure composed of a first metal layer and a second metal layer disposed in this order as seen from the side of the other surface of the substrate, and the coefficient of thermal expansion of the first metal layer by heating is greater than the coefficient of thermal expansion of the second metal layer by heating under the same temperature condition.

8. The mold structure according to claim 5, wherein the metal layers are heated locally or entirely.

9. The mold structure according to claim 7, wherein the first metal layer is a spring layer with springiness, and the second metal layer is a shape memory alloy layer composed of a shape memory alloy.

10. An imprinting method comprising:
pressing a mold structure against a resist layer, which is composed of an imprint resist composition and formed on a substrate of an object to be processed, so as to transfer a concavo-convex pattern of the mold structure to the resist layer; and
heating a release plate so as to thermally expand at least two metal layers and thus to allow an end of the mold structure to curve in a direction opposite to the pressing direction, and thereby separating the mold structure from the resist layer,
wherein the mold structure is a mold structure used to press against a resist layer composed of an imprint resist composition, which comprises: a substrate; the concavo-convex pattern which is composed of a plurality of convex portions and formed on one surface of the substrate; and the release plate provided on the other surface of the substrate opposite to the one surface,
wherein the release plate is a release plate that is provided on a mold structure for use in an imprinting method in which a concavo-convex pattern is transferred to a resist layer composed of an imprint resist composition on a substrate, and that is used to separate the mold structure from the resist layer, and
wherein the release plate comprises the at least two metal layers which curve by heating and return to their original shape at normal temperature.

11. The imprinting method according to claim 10, wherein the metal layers are heated locally or entirely.
